(19) United States
(12) Patent Application Publication
(10) Pub. No.: US 2014/0207679 A1
(43) Pub. Date: Jul. 24, 2014

(54) ONLINE MONEY TRANSFER SERVICE IN CONNECTION WITH INSTANT MESSENGER

(71) Applicant: KT CORPORATION, Gyeonggi-do (KR)

(72) Inventor: Young-Bin CHO, Seoul (KR)

(73) Assignee: KT CORPORATION, Gyeonggi-do (KR)

(21) Appl. No.: 14/160,787

(22) Filed: Jan. 22, 2014

(30) Foreign Application Priority Data
Jan. 23, 2013 (KR) 10-2013-0007289

(51) Int. Cl. G06Q 20/32; G06Q 20/10

(52) U.S. Cl. CPC G06Q 20/3255; G06Q 20/10
USPC 705/44; 705/39

(57) ABSTRACT

The disclosure is related to performing online money transfer operation in connection with an instant messenger installed in and executed by user equipment. First user equipment may monitor messages transmitted to and received from second user equipment through the instant messenger upon initiation of the online money transfer operation. The first user equipment may obtain information on an online money transfer event upon detection of a predetermined service initiation word based on the monitoring result. The first user equipment requests a service server to perform the online money transfer operation based on the obtained information.

### CROSS REFERENCE TO PRIOR APPLICATIONS

The present application claims priority under 35 U.S.C. §119 to Korean Patent Application No. 10-2013-0007289 (filed on Jan. 23, 2013), which is hereby incorporated by reference in its entirety.

### BACKGROUND

The present disclosure relates to an online money transfer service and, particularly, to providing an online money transfer service in connection with an instant messenger. Use of an instant messenger on a mobile communication device like a smartphone has become popular. Lately, many different kinds of services have been introduced and provided through the instant messenger.

Wireless communication services providers have developed a next generation communication service, Rich Communication Suite (RCS). RSC has been commercialized and has been used as an IP Multimedia Subsystem (IMS) based GSMA international standard that suggests a method to provide efficient IP based communication services (e.g., an instant messaging service, a short message service (SMS), and a multimedia message service (MMS)) at a functional unit. One of primary functions of RCS is an Enhanced Messaging service. Such Enhanced message service allows a history search of exchanged messages while the messages are exchanged like typical conversation between two parties. Various services have been developed using such primary functions of RCS in connection with an instant messenger.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present disclosure, an online money transfer service may be provided through user equipment in association with an instant messenger application.

In accordance with another aspect of the present disclosure, a user is able to transfer money through an instant messenger service of user equipment without installing and executing additional application installed in the user equipment.

In accordance with still another aspect of the present disclosure, an online money transfer operation may be performed using an instant messenger without entering detailed information on bank accounts and perform additional authentication process.

In accordance with yet another aspect of the present disclosure, a user may be enabled to perform an online money transfer operation while chanting with others through an instant messenger without activating additional applications.

In accordance with yet another aspect of the present disclosure, a user may be enabled to perform an online money transfer operation using user equipment without performing additional authentication process because communication service servers of both parties in communication already authenticated the user equipment in communication.

In accordance with at least one embodiment, a method may be provided for performing online money transfer operation in connection with an instant messenger at first user equipment. The method may include monitoring messages transmitted to and received from second user equipment through the instant messenger upon initiation of the online money transfer operation, obtaining information on an online money transfer event upon detection of a predetermined service initiation word based on the monitoring result, and requesting a service server to perform the online money transfer operation based on the obtained information.

The monitoring messages may include initiating the online money transfer operation upon initiation of the instant messenger, determining whether any word in the messages is matched with a predetermined service initiation word, and invoking an online money transfer event when at least one word in the messages is matched with the predetermined service initiation word. The predetermined service initiation word may be set by at least one of associated user, a service provider, and a system designer and is made of any combination of alphabets, numbers, characters, and symbols.

The obtaining information on an online money transfer event may include analyzing messages exchanged between the first user equipment and the second user equipment before the predetermined service initiation word and related to the online money transfer event and detecting the information on the online money transfer event based on the analysis result. The information on the online money transfer event may include at least one of a sender, a recipient, a transfer amount, a transfer date, a transfer time, a transfer method, and a telephone number.

The requesting a service server may include generating an online money transfer request to include the obtained information on the online money transfer event and transmitting the generated online money transfer request to the service server.

The method may further include receiving a confirmation message from the service server in response to the requesting and displaying the confirmation message within a graphic user interface of the instant messenger and inquiring an associated user to select one of confirmation approval and for confirmation denial. The displayed confirmation message may include at least one of a sender, a recipient, a transfer amount, a transfer date, a transfer time, a transfer method, and a telephone number, which are determined by the service server based on the information included in the online money transfer request.

The method may further include transmitting at least one of a confirmation approval message and a confirmation denial message to the service server based on the user selection and receiving an online money transfer result from the service server.

The method may further include storing the received online money transfer result, the detected service initiation word, and the messages related to the invoked online money transfer event in a universal subscriber identity module (USIM) of the first user equipment.

In accordance with at least one embodiment, a method may be provided for performing an online money transfer operation at a service server. The method may include receiving an online money transfer request from first user equipment in order to transfer money from the first user equipment to second user equipment, obtaining information on an online money transfer event from the received online money transfer request, and performing an online money transfer operation based on the obtained information. The online money transfer request may be generated by the first user equipment when the first user equipment detects a predetermined service initiation word included in messages transmitted to and received from others through an instant messenger.

The obtaining information may include extracting the information on the online money transfer event from the received online money transfer request and determining a sender, a recipient, a transfer amount, a transfer date, and a transfer time based on the extracted information.

The method may include generating a confirmation message to include the obtained information on the online money transfer event and transmitting the generated confirmation message to the first user equipment and the second user equipment in order to confirm the obtained information with the first user equipment and the second user equipment.

The generating a confirmation message may include determining a sender, a recipient, a transfer amount, a transfer date, and a transfer time based on the obtained information on the online money transfer event, generating the confirmation message to include information on the determined sender, the determined recipient, the determined transfer amount, the determined transfer date, and the determined transfer time, and transmitting the generated confirmation message to the first user equipment and second user equipment in order to confirm at least one of the determined sender, the determined recipient, the determined transfer amount, the determined transfer date, and the determined transfer time.

The performing an online money transfer operation may include requesting communication service servers of the first user equipment and the second user equipment to perform a money transfer operation between service accounts associated with the first user equipment and the second user equipment based on the obtained information when a confirmation approval message is received from both of the first user equipment and the second user equipment.

After performing the money transfer operation, the communication service servers of the first user equipment and the second user equipment may perform one of: generating an invoice based on the transferred amount of money and sending out the generated invoice to the first user equipment and the second user equipment; and electrically withdrawing the transferred amount of money from or depositing the transferred amount of money to bank accounts associated with the first user equipment and the second user equipment.

The method may include generating an online money transfer result message to include information on a result of perform the online money transfer operation and transmitting the generated result message to the first user equipment and the second user equipment.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates an online money transfer service provided in association with an instant messenger in accordance with at least one embodiment;

FIG. 2 illustrates user equipment for an online money transfer service in connection with an instant messenger in accordance with at least one embodiment;

FIG. 3 illustrates an operation of user equipment for an online money transfer service in connection with an instant messenger installed in user equipment in accordance with at least one embodiment;

FIG. 4 illustrates an operation of a service server for providing an online money transfer service in connection with an instant messenger in accordance with at least one embodiment; and

FIG. 5 illustrates graphic user interfaces of user equipment for an online money transfer service in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with at last one embodiment, an online money transfer service is performed through user equipment in connection with an instant messenger. Such an online money transfer service enables a sender to transfer money to a receiver using an instant messenger while communicating with each other through the instant messenger. The online money transfer service does not require performing additional authentication operations and activating additional applications installed in user equipment. Hereinafter, an overall view of the online money transfer service will be described with reference to FIG. 1.

FIG. 1 illustrates an online money transfer service provided in association with an instant messenger in accordance with at least one embodiment. Referring to FIG. 1, an online money transfer service is provided in association with an instant messenger installed and executed in user equipment in accordance with at least one embodiment. In order to provide such an online money transfer service, first user equipment 110 and second user equipment 120 are coupled to service server 200 and are also respectively coupled to associated communication service servers (e.g., first communication server 310 and second communication server 320) through communication network 400.

First and second user equipment 110 and 120 may be electronic device having processing power and communication capability. For example, first and second user equipment 110 and 120 may include a personal computer (PC), a smartphone, a laptop computer, a personal digital assistance (PDA), a portable multimedia player (PMP), and a navigation device, but the present invention is not limited thereto.

Each individual uses such first and second user equipment 110 and 120 for the online money transfer service in connection with an instant messenger. For example, first and second user equipment 110 and 120 are subscribers of a communication service provided by first and second communication service servers 310 and 320. Although first and second user equipment 110 and 120 are described as receiving a communication service from different communication service servers 310 and 320, the present invention is not limited thereto. First and second user equipment 110 and 120 may receive a communication service from the same communication service server.

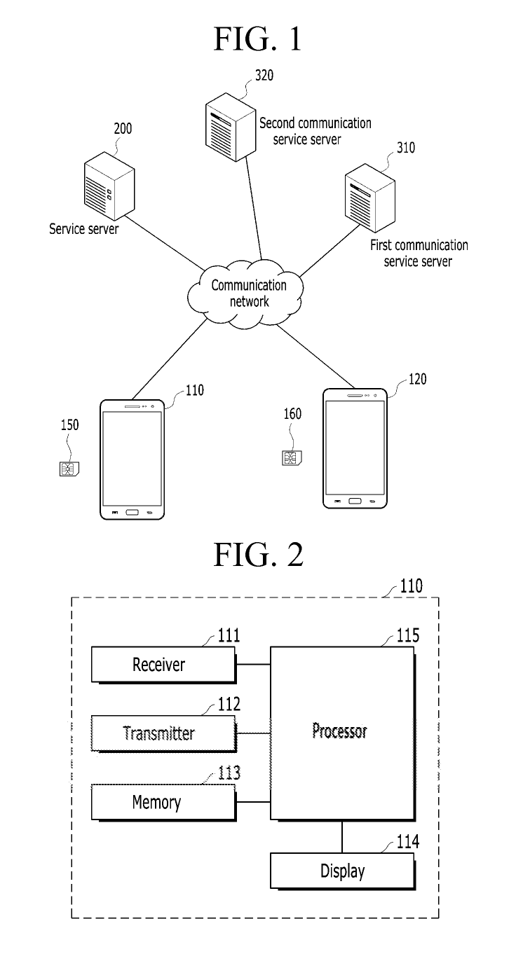

Using a communication service provided by communication service servers 310 and 320, first and second user equipment 110 and 120 transmit and receive a voice call, a text, and multimedia data to or from others through communication network 400. Furthermore, first and second user equipment 110 and 120 may be coupled directly to the Internet using a WiFi MODEM thereof or indirectly to the Internet through a communication service server. Each one of first and second user equipment 110 and 120 includes identification circuit in a form of a smart card, such as a universal subscriber identity module (USIM) 150 or 160 (e.g., 112 in FIG. 2). One of communication service servers 310 and 320 authenticates first and second user equipment 110 and 120 based on information included in such a USIM.

Communication service servers 310 and 320 may be a computing system of a communication service provider. Communication service severs 310 and 320 authenticate a subscriber based on a USIM of each user equipment and provides various types of communication services to the authenticated user equipment.

In addition, communication service servers 310 and 320 provide an online money transfer service in association with service server 200. For example, service server 200 transmits a request message to communication service servers 310 and 320 with the information on the online money transfer event invoked by first and second user equipment 110 and 120. In response to the request, communication service servers 310 and 320 exchange information to each other in order to transfer money based on the information on the online money transfer event.

That is, when first user equipment 110 wants to transfer money to second user equipment 120, first communication service server 310 of first user equipment 110 transfers money to second communication service server 320 of second user equipment 120 using service accounts associated with first and second user equipment 110 and 120 based on associated agreement between communication service providers and between communication service providers and users. Then, each communication service sever generates and sends out a bill to respective users based on the money transaction maybe with a certain amount of communication service fee. Alternatively, each communication service server automatically withdraws the associated amount of money from or adds the associated amount of money to bank accounts associated with respective users based on the money transaction between two communication service providers. Since such transaction operations between the communication service providers and between the communication service provider and the associated bank may be performed using various methods, the present invention is not limited to one specific method.

Such an online money transfer operation may be performed in various methods. Accordingly, the present invention is not limited to one specific method. For example, the online money transfer operation may be performed in connection with communication service providers as described, in connection with a third party money transfer service provider (e.g., PayPal), and in connection with associated banks

Service server 200 may be a computing system of a service provider that provides an online money transfer service to individuals. As described, the online money transfer service might enable a sender to transfer money to a receiver using an instant messenger while communicating with each other through the instant messenger. For example, service server 200 receives an online money transfer request from user equipment when an online money transfer event is invoked at the user equipment. Upon the receipt of the online money transfer request, service server 200 obtains detailed information on the online money transfer event from the online money transfer request. Based on the obtained information, service server 200 generates a confirmation message and transmits to user equipment in order to confirm the obtained information on the online money transfer event. Upon the receipt of a confirmation approval message from both parties, service server 200 may perform the online money transfer operation in connection with communication service providers 310 and 320.

Service server 200 was described as a server independent from an instant messenger service server (not shown), but the present invention is not limited thereto. For example, service server 200 may be internally included in the instant massager service server or may internally include the instant message service server. That is, one service server may provide not only the online money transfer service and the instant messenger service.

As described, the online money transfer service may be provided through first and second user equipment 110 and 120 in connection with an instant messenger in accordance with at least one embodiment. Hereinafter, such user equipment will be described with reference to FIG. 2.

FIG. 2 illustrates user equipment for an online money transfer service in connection with an instant messenger in accordance with at least one embodiment. Referring to FIG. 2, user equipment 110 includes communication circuit 111, identification circuit 112, memory 113, display 114, and processor 115.

Communication circuit 111 transmits signal to and receives signals from other entities (e.g., service server 200, communication service server 310, and second user equipment 120) through communication network 400 based on various types of communication schemes. For convenience and ease of understanding, user equipment 110 is illustrated as having one communication circuit in FIG. 2, but the present invention is not limited thereto. For example, user equipment 110 may include more than two communication circuits each employing different communication scheme.

Communication circuit 111 may be referred to as a transceiver and include at least one of a mobile communication circuit, a wireless internet circuit, a near field communication (NFC) circuit, a global positioning signal receiving circuit, and so forth. Particularly, communication circuit 111 may include a short distance communication circuit for short distance communication, such as NFC, and a mobile communication circuit for long range communication through a mobile communication network, such as long term evolution (LTE) communication or wireless data communication (e.g., WiFi).

Identification circuit 112 is a subscriber identification module. For example, identification circuit 112 may be a smart card such as a universal subscriber identity module (USIM). Communication service server 310 authenticates first user equipment 110 based on information included in identification circuit 112. Since first user equipment 110 and second user equipment 120 are authenticated by communication service servers 310 and 320 through information included in respective identification circuits thereof, the online money transfer service may be performed without performing the authentication process again.

Identification circuit 112 may include a memory for storing data related to the online money transfer operation. The data related to the online money transfer operation may include information on messages exchanged between two user equipment, which are related to the online money transfer operation, and information on a result of the online money transfer operation. Such data may be encrypted before storing in the memory of identification circuit 112, but the present invention is not limited thereto. Such data may be stored in memory 113 of user equipment 110. In addition, such data may be stored in a memory of a cloud system coupled through communication network 400. The stored data may be used as a receipt or an evidence to approve money transaction between two parties.

Memory 113 stores various types of data including operating system for controlling user equipment 110, an instant messenger application, and at least one application necessary for providing the online money transfer service in accordance with at least one embodiment. For example, memory 113 may store an instant messenger application for online chat in real-time text transmission and an online money transfer service application for enabling a sender to transfer money to a receiver using the instant messenger while communicating with each other through the instant messenger. The instant messenger application was described as being independent from the application for an online money transfer service, but the present invention is not limited thereto. The instant messenger application may have features of an online money transfer application or the online money transfer application may have features of the instant messenger application. Furthermore, memory 113 may further store data generated or received from others while performing the online money transfer operations.

Display 114 displays various types of data and message generated in user equipment 110. For example, display 114 displays the result of processing based on the received input through a graphic user interface. Display 114 displays various graphic user interfaces as a result of initiating various types of applications associated with the instant messenger application and the online money transfer service and displaying information generated as a result of performing the applications through the graphic user interfaces.

Processor 115 is a central processing circuitry that controls constituent elements of user equipment 110, such as communication circuit 111, identification circuit, memory 113, and display 114 based on inputs received from associated users or based on results of performing operations associated with the instant messenger service and the online money transfer service.

For example, processor 115 performs operations for activating or executing the instant messenger application. Such instant messenger application enables an associated user to send messages to and receive messages from others over communication network 400. Particularly, processor 115 performs operations for sending a service request to an associated messenger service server with information on a desired recipient. In response to the request, the associated messenger service server delivers messages between at least two user equipments. The associated messenger service server was described as an independent dedicated server for providing such an instant messenger service, but the present invention is not limited thereto. For example, service server 200 may perform such an instant messenger service as well as an online money transfer service. Such instant messenger application may employ RCS features. Accordingly, the instant messenger application allows a history search of messages exchanged between both parties.

Processor 115 performs operation for analyzing messages exchanged between a sender (e.g., first user equipment 110) and a receiver (e.g., second user equipment and detects a service initiation word invoking an online money transfer event based on the analysis result. The service initiation word may be a word in messages, which initiates an online money transfer operation. Such service initiation word may be set by at least one of an associated user, a system designer, and a service provider. For example, the service initiation word may include “online-transaction”, “online-transfer”, “need-money”, “send-money”, “@transfer”, “@online-transfer”, “transfer-now”, “online money transfer service”, and so forth. The service initiation word may be any combination of alphabets, numbers, characters, and symbols. Upon the detection of the service initiation word, message analyzer 210 requests a related online transaction processing service, such as a mileage transaction or financial transaction.

Processor 115 also performs operation for obtaining detailed information on the online transfer event by analyzing messages exchanged between both parties. For example, the detailed information on the online money transfer event includes at least one of an amount of money to transfer, a date or a time for transferring, a transfer method (e.g., through a bank, an online money transfer service provider, or a communication service provider), a recipient (e.g., an owner of second user equipment 120), and so forth. Processor 115 performs an operation for generating and transmitting an online money transfer request to service server 200, an operation for receiving a confirmation message from service server 200, and an operation for receiving an online transfer result message from service server 200. Processor 115 further performs an operation for recording messages, confirmation message, and result messages related to the online transfer event in memory 114 or a memory in identification circuit 112. Such stored information may be used as a receipt or an evidence for approving money transaction between two parties.

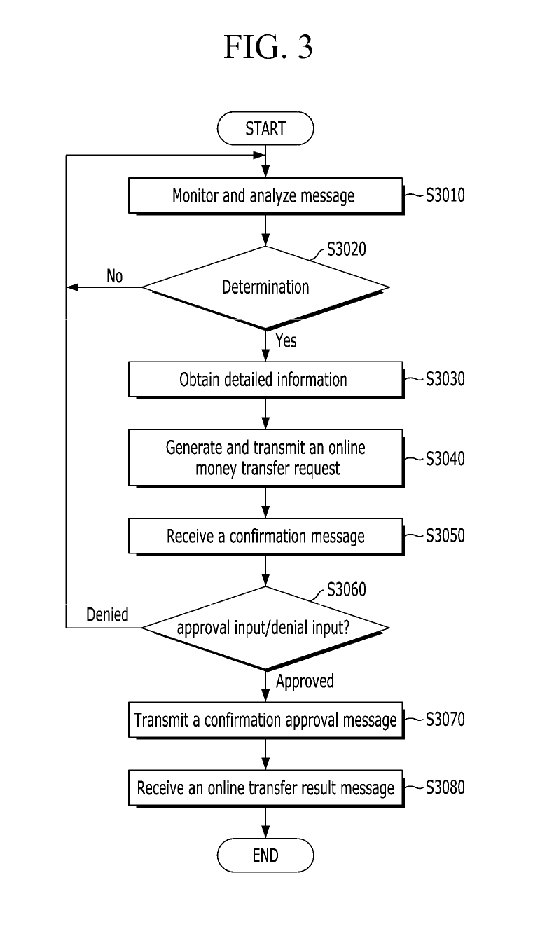

As described, users are able to transfer money to others without performing complicated processes of entering detail banking information and annoying authorization process. Such an online money transfer service may be performed through an instant messenger application installed in and executed by the user equipment. In addition, a dedicated application for the online money transfer service may be installed in and executed by the user equipment in connection with the instant messenger application. The online money transfer operation may be activated upon the initiation of user equipment 110, upon the initiation of an instant messenger installed in user equipment 110, or upon the activation of an icon of the associated application, which is displayed within a default graphic user interface displayed on a display of user equipment 110. Hereinafter, such an operation of user equipment for an online money transfer service in connection with an instant messenger will be described with reference to FIG. 3.

FIG. 3 illustrates an operation of user equipment for an online money transfer service in connection with an instant messenger installed in user equipment in accordance with at least one embodiment.

Referring to FIG. 3, messages are monitored and analyzed in real-time at step S3010. For example, a user of first user equipment 110 activates an instant messenger application installed in first user equipment 110 and communicates with another (e.g., second user equipment 120) through the instant messenger. Upon the activation of such an instant messenger, first user equipment 110 may activate an online money transfer operation. Such an online money transfer operation may be one of functions of the instant messenger or is performed by a dedicated application which may be downloaded from service server 200 and installed in first user equipment 100. The present invention, however, is not limited thereto. The online money transfer service operation may be activated upon the initiation of first user equipment 110 or upon the activation of the online money transfer service by clicking an icon of the online money transfer service, displayed on a display of first user equipment 110. Upon the activation of the online money transfer service application, first user equipment 110 starts monitoring and analyzing messages exchanged among the user with others in real time.

At step S3020, determination is made so as whether at least one service initiation word related to the online money transfer service is detected based on the monitor and analysis result. For example, first user equipment 110 analyzes each word of messages exchanged between first user equipment 110 and second user equipment 120 and determines whether each word is matched at least one of service initiation words invoking an online money transfer event. Such service initiation words may be set up by at least one of a user, a system designer, and a service provider, but the present invention is not limited thereto. Particularly, the service initiation word may include “online-transaction”, “online-transfer”, “need-money”, “send-money”, “@transfer”, “@online-transfer”, “transfer-now”, “online money transfer service”, and so forth. The service initiation word may be any combination of words, numbers, characters, and symbols.

When the service initiation word is detected (Yes-S3020), detailed information on the online transfer event is obtained by analyzing messages exchanged between first user equipment 110 and second user equipment 120 at step S3030. Otherwise (No-S3020), messages are continuously monitored and analyzed in real-time at step S3010.

For example, first user equipment 110 determines that the online money transfer event is invoked when the service initiation word is detected. Upon the invocation of the online money transfer event, first user equipment 110 collects detailed information on the online money transfer event by analyzing messages previously exchanged in a certain time period between first user equipment 110 and second user equipment 120. For example, the detailed information on the online money transfer event includes at least one of an amount of money to transfer, a transfer date, a transfer time, a recipient (e.g., an owner of second user equipment 120), and so forth.

In accordance with at least one embodiment, the online money transfer service transfers money through a communication service provider (e.g., communication service servers). That is, one of associated communication service providers transfers money to the other between associated service accounts for a communication service. After the communication service provider transfers the money, the communication service provider may send out an invoice or automatically withdraw the money from an associated bank account. The present invention, however, is not limited thereto. Money may be transferred through associated banks, an online money transfer service provider (e.g., service server 200), or a third company for online money transfer service (e.g., PayPal). Accordingly, the detailed information may further include information on a transfer method (e.g., through a bank, an online money transfer service provider, or a communication service provider).

At step S3040, an online money transfer request is generated and transmitted. For example, first user equipment 110 generates the online money transfer request to include the obtained detailed information on the online money transfer event. That is, the generated online money transfer request may include information on a recipient (e.g., an owner of second user equipment 120), a transfer money amount, a transfer date, a transfer time, a transfer method, and thereof. Then, first user equipment 110 transmits the generated online money transfer request to service server 200.

At step S3050, a confirmation message is received in response to the online money transfer request. For example, first user equipment 110 receives a confirmation message for online money transfer from service server 200. That is, Service server 200 receives the online money transfer request from first user equipment 110, extracts the detailed information on the online money transfer event, and determines a sender, a recipient, a transfer amount, a transfer date, a transfer time, and so forth. In addition, service server 200 may obtain associated account information from communication service provider servers of first user equipment 110 and second user equipment 120. Service server 200 generates a confirmation message in order to confirm the determined information with first and second user equipment 110 and 120. Accordingly, service server 200 generates such a confirmation message to include the determined information such as the determined recipient, the determined transfer amount, the determined transfer date, and the determined transfer time. Service server 200 transmits the generated confirmation message to first user equipment 110.

Accordingly, the received confirmation message includes information on a sender (e.g., an owner of first user equipment 110), a recipient (e.g., an owner of second user equipment 120), a transfer amount, and a transfer date and time, but the present invention is not limited thereto. First user equipment 110 displays the received confirmation message within a graphic user interface of the instant message application, but the present invention is not limited thereto.

In addition, such confirmation message may be transmitted not only to first user equipment 110 but also to second user equipment 120. That is, service server 200 transmits the confirmation message to all of user equipment participated in the online money transfer event. Accordingly, second user equipment 120 also displays the received confirmation message within a graphic user interface of the instant messenger application.

At step S3060, one of a confirmation approval input and a confirmation denial input is received from an associated user. For example, when the displayed confirmation message contains no errors, an associated user may input the confirmation approval input. Otherwise, the associated user may input the confirmation denial input. Furthermore, when an associated user does want such online money transfer service, the associated user enters the confirmation denial input.

In case of the confirmation approval input (Approve-S3060), a confirmation approve message is transmitted at step S3070. For example, upon the receipt of the confirmation approval input from an associated user, first user equipment 110 transmits the confirmation approval message to service server 200. Otherwise (Denial-S3060), messages are continuously monitored and analyzed at step S3010.

At step S3080, an online transfer result message is received. For example, when service server 200 receives the confirmation approval message from both of parties of communication (e.g., first and second user equipment 110 and 120), service server 200 performs an online money transfer operation based on the determined information. As described, the online money transfer operation may be performed in various methods. Particularly, the online money transfer operation may be performed in connection with communication service providers, in connection with a third party service provider, and in connection with banks

Furthermore, the online transfer result message, the detected service initiation word, and the messages related to the online money transfer event may be stored in USIMs of first user equipment 110 and second user equipment 120. Such stored information may be used as a receipt or an evidence of the online money transfer operation performed between first user equipment 110 and second user equipment 120.

In accordance with at least one embodiment, the online money transfer operation is performed in connection with communication service providers. For example, service server 200 transmits a request message to communication service servers (e.g., a server of a communication service provider) of first user equipment 110 and second user equipment 120 with the information on the online money transfer event. In response to the request, the communication service servers perform operation for transferring money based on the information on the online money transfer event. That is, when first user equipment 110 wants to transfer money to second user equipment 120, the communication service server of first user equipment 110 transfers money to the communication service server of second user equipment 120 (e.g., from a service account of first user equipment 110 to a service account of second user equipment 120) based on associated agreement between the communication service providers. Then, each communication service sever generates and sends out a bill to respective users based on the money transaction with a communication service fee. Alternatively, communication service servers automatically withdraw the associated amount of money from or add the associated amount of money to bank accounts associated with respective users based on the money transaction between two communication service providers. Since such transaction operations between the communication service providers and between the communication service provider and the associated bank may be performed using various methods, the present invention is not limited to one specific method.

After finishing the transaction between two parties, service server 200 transmits information on the transaction not only to first user equipment 110 but also to second equipment 120. First user equipment 110 and second user equipment 120 may display the received information within a graphic user interface of the instant messenger application.

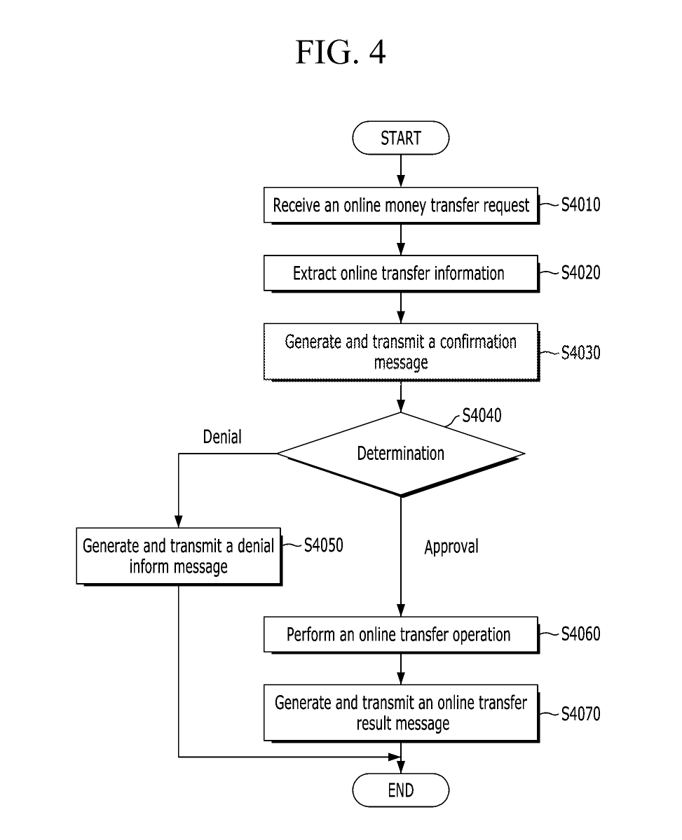

As described, service server 200 receives an online money transfer request from first user equipment 110 and performs an online money transfer operation based on the information included in the online money transfer request in association with communication service servers 310 and 320 in accordance with at least one embodiment. Such operation of service server 200 will be described with reference to FIG. 4. For convenience and ease of understanding, the online money transfer operation will be described as being performed through communication service servers 310 and 320, but the present invention is not limited thereto. The online money transfer operation may be performed in connection with a server of bank associated with each user equipment or a server of third company for online money transfer service (e.g., PayPal).

FIG. 4 illustrates an operation of a service server for providing an online money transfer service in connection with an instant messenger in accordance with at least one embodiment. Referring to FIG. 4, an online money transfer request is received as step S4010. For example, service server 200 receives the online money transfer request from first user equipment 110.

At step S4020, online transfer information is extracted from the received online money transfer request. For example, service server 200 extracts the detailed information on the online money transfer event, and determines a recipient, a transfer amount, a transfer date, a transfer time, and so forth. For convenience and ease of understanding, the recipient will be described as an owner of second user equipment 120, but the present invention is not limited thereto.

In addition, associated account information may be obtained. For example, service server 200 may obtain service account information or bank account information associated with first user equipment 110 and second user equipment 120. In accordance with at least one embodiment, service server 200 requests such information to associated communication service servers. The associated communication service servers may provide such account information to service server 200 with permission from associated users. However, the present invention is not limited thereto. Such information may be obtained from first and user equipment 110 and 120. In addition, service server 200 may store bank account information of each service subscriber in own database. Upon the registration of the online money transfer service, service server 200 obtains such bank account information from each subscriber and stores and manages the obtained bank account information in own database.

At step S4030, a confirmation message is generated and transmitted to user equipment. For example, service server 200 generates a confirmation message in order to confirm the determined information on the online money transfer event. Accordingly, service server 200 generates such a confirmation message to include the determined information such as the determined recipient, the determined transfer amount, and the determined date and time for transfer. Service server 200 transmits the generated confirmation message not only to first user equipment 110 but also to second user equipment 120.

At step S4040, determination is made so as whether a confirmation approval message is received from both parties. For example, in response to the confirmation message, service server 200 may receive responding messages from first user equipment 110 and second user equipment 120. Upon the receipt of the responding message, service server 200 determines whether the received message is a confirmation approval message or a confirmation denial message.

When the confirmation denial message is received from at least one of first user equipment 110 and second user equipment 120 (Otherwise-S4040), service server 200 generates a denial inform message and transmits the denial inform message to first user equipment 110 and second user equipment 120 at step S4050. For example, when at least one of users of first user equipment 110 and second user equipment 120 does not want to perform the online money transfer operation, when information in the confirmation message is incorrect, or when the online money transfer event is invoked by mistake, such operation may be canceled by selecting a denial option displayed with the confirmation message. In this case, service server 200 receives the confirmation denial message from at least one of first user equipment 110 and second user equipment 120. Upon the receipt of the confirmation denial message, service server 200 discards the current money transfer operation and waits for another online money transfer request.

When the confirmation approval message is received from both parties (Approval message-S4050), an online money transfer operation is performed at step S4060. For example, service server 200 receives the confirmation approval message from both of first user equipment 110 and second user equipment 120. In this case, service server 200 performs the online money transfer operation based on the information on the online money transfer event. In accordance with at least one embodiment, the online money transfer operation is performed in connection with communication service providers.

For example, service server 200 transmits a request message to communication service servers (e.g., a server of a communication service provider) of first user equipment 110 and second user equipment 120 with the information on the online money transfer event. In response to the request, the communication service servers perform operation for transferring money based on the information on the online money transfer event. That is, when first user equipment 110 wants to transfer money to second user equipment 120, the communication service server of first user equipment 110 transfers money to the communication service server of second user equipment 120 from an associated service account of first user equipment 110 to an associated service account of second user equipment 120 based on associated agreement between the communication service providers. Then, each communication service sever generates and sends out a bill to respective users based on the money transaction with a communication service fee. Alternatively, communication service servers may automatically withdraw the transferred money from or add the transferred money to bank accounts associated with respective users based on the money transaction between two communication service providers.

At step S4070, an online transfer result message is generated and transmitted. For example, service server 200 generates the online transfer result message to include information on the money transfer operation between the communication service providers. Then, service server 200 transmits the generated online transfer result message to first user equipment 110 and second user equipment 120.

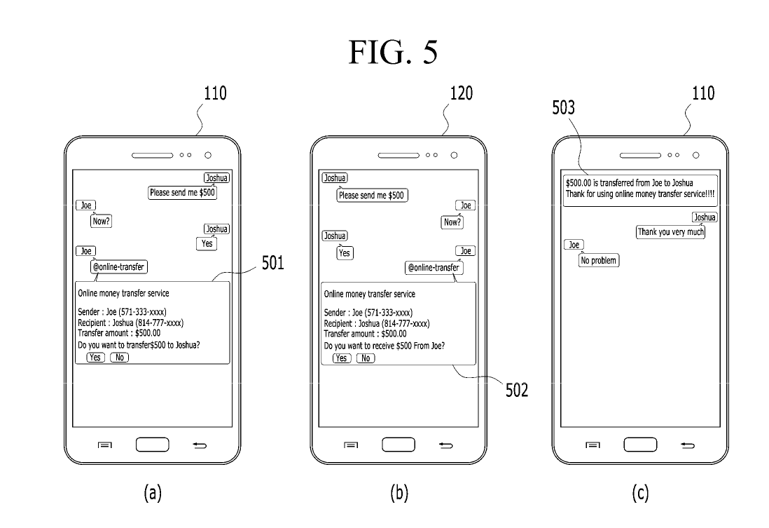

Hereinafter, an online money transfer service in accordance with at least one embodiment will be described with exemplary graphic user interfaces displayed on each user equipment with reference to FIG. 5.

FIG. 5 illustrates graphic user interfaces of user equipment for an online money transfer service in accordance with at least one embodiment. As shown in a diagram (a) of FIG. 5, first user equipment 110 displays a graphic user interface of an instant messenger and provides a messenger service through such a graphic user interface. Upon the detection of a service initiation word “@online transfer” 501, first user equipment 110 initiates an online money transfer event and analyzes messages to determine detail information of the online money transfer event. For example, first user equipment 110 determines that Joe (e.g., first user equipment 110) wants to send $500.00 to Joshua (e.g., second user equipment 120) based on messages exchanged between first user equipment 110 and second user equipment 120. First user equipment 110 transmits the generated online money transfer request with the determined detail information on the online money transfer event to service server 200.

In response to the online money transfer request, service server 200 generates a confirmation message and transmits the confirmation message 502 to first user equipment 110 (e.g., sender). As shown in a diagram (a) of FIG. 5, first user equipment 110 receives and displays the confirmation message 502 that includes information on a sender, a recipient, a transfer amount, and a time and date for transfer. The present invention, however, is not limited thereto. Such information may differ depending on a transfer method or a system design. For example, the information may further include associated service account information, associated bank account information, and a telephone number.

The confirmation message 502 may be displayed as a pop-up message or a text message within a graphic user interface of the instant messenger, but the present invention is not limited thereto. In addition, the confirmation message includes an interactive icon or button for enabling a user to approve (e.g., YES) or to denial (e.g., NO) to transfer money to second user equipment 120.

In response to the online money transfer request, service server 20 also generates a confirmation message and transmits the confirmation message 503 to second user equipment 120 (e.g., recipient). As shown in a diagram (b) of FIG. 5, second user equipment 120 receives and displays the confirmation message 503 that includes information on a sender, a recipient, a transfer amount, a time and date for transfer, and associated bank account. The present invention, however, is not limited thereto. Such information may differ depending on a transfer method or security purpose. For example, the associated bank account information may be omitted. In addition, the confirmation message includes an interactive icon or button for enabling a user to approve (e.g., YES) or to denial (e.g., NO) to receive money from first user equipment 110.

Upon the receipt of the confirmation approval messages from both of first and second user equipment 110 and 120, service server 200 performs the online money transfer operation based on the detailed information on the online money transfer event. After the online money transfer operation is performed, service server 200 transmits information on the online money transfer result 504 to first and second user equipment 110 and 120. First and second user equipment 110 and 120 receive and displays the online money transfer result information 504 as shown in a diagram (c) of FIG. 5.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of performing online money transfer operation in connection with an instant messenger at first user equipment, the method comprising:
monitoring messages transmitted to and received from second user equipment through the instant messenger upon initiation of the online money transfer operation;
obtaining information on an online money transfer event upon detection of a predetermined service initiation word based on the monitoring result; and
requesting a service server to perform the online money transfer operation based on the obtained information.

2. The method of claim 1, wherein the monitoring messages includes:
initiating the online money transfer operation upon initiation of the instant messenger;
determining whether any word in the messages is matched with a predetermined service initiation word; and
invoking an online money transfer event when at least one word in the messages is matched with the predetermined service initiation word.

3. The method of claim 1, wherein the predetermined service initiation word is set by at least one of associated user, a service provider, and a system designer and is made of any combination of alphabets, numbers, characters, and symbols.

4. The method of claim 1, wherein the obtaining information on an online money transfer event includes:
analyzing messages exchanged between the first user equipment and the second user equipment before the predetermined service initiation word and related to the online money transfer event; and
detecting the information on the online money transfer event based on the analysis result.

5. The method of claim 1, wherein the information on the online money transfer event includes at least one of a sender, a recipient, a transfer amount, a transfer date, a transfer time, a transfer method, and a telephone number.

6. The method of claim 1, wherein the requesting a service server includes:
generating an online money transfer request to include the obtained information on the online money transfer event; and
transmitting the generated online money transfer request to the service server.

7. The method of claim 1, comprising:
receiving a confirmation message from the service server in response to the requesting; and
displaying the confirmation message within a graphic user interface of the instant messenger and inquiring an associated user to select one of confirmation approval and for confirmation denial.

8. The method of claim 7, wherein the displayed confirmation message includes at least one of a sender, a recipient, a transfer amount, a transfer date, a transfer time, a transfer method, and a telephone number, which are determined by the service server based on the information included in the online money transfer request.

9. The method of claim 1, comprising:
transmitting at least one of a confirmation approval message and a confirmation denial message to the service server based on the user selection; and
receiving an online money transfer result from the service server.

10. The method of claim 1, comprising:
storing the received online money transfer result, the detected service initiation word, and the messages related to the invoked online money transfer event in a universal subscriber identity module (USIM) of the first user equipment.

11. A method of online money transfer operation at a service server, the method comprising:
receiving an online money transfer request from first user equipment in order to transfer money from the first user equipment to second user equipment;
obtaining information on an online money transfer event from the received online money transfer request; and
performing an online money transfer operation based on the obtained information.

12. The method of claim 11, wherein the online money transfer request is generated by the first user equipment when the first user equipment detects a predetermined service initiation word included in messages transmitted to and received from others through an instant messenger.

13. The method of claim 11, wherein the obtaining information includes:
extracting the information on the online money transfer event from the received online money transfer request; and
determining a sender, a recipient, a transfer amount, a transfer date, and a transfer time based on the extracted information.

14. The method of claim 11, comprising:
generating a confirmation message to include the obtained information on the online money transfer event; and
transmitting the generated confirmation message to the first user equipment and the second user equipment in order to confirm the obtained information with the first user equipment and the second user equipment.

15. The method of claim 14, wherein the generating a confirmation message includes:
determining a sender, a recipient, a transfer amount, a transfer date, and a transfer time based on the obtained information on the online money transfer event;
generating the confirmation message to include information on the determined sender, the determined recipient, the determined transfer amount, the determined transfer date, and the determined transfer time; and
transmitting the generated confirmation message to the first user equipment and second user equipment in order to confirm at least one of the determined sender, the determined recipient, the determined transfer amount, the determined transfer date, and the determined transfer time.

16. The method of claim 11, wherein the performing an online money transfer operation includes:
requesting communication service servers of the first user equipment and the second user equipment to perform a money transfer operation between service accounts associated with the first user equipment and the second user equipment based on the obtained information when a confirmation approval message is received from both of the first user equipment and the second user equipment.

17. The method of clam 16, wherein after performing the money transfer operation, the communication service servers of the first user equipment and the second user equipment perform one of:
generating an invoice based on the transferred amount of money and sending out the generated invoice to the first user equipment and the second user equipment; and
electrically withdrawing the transferred amount of money from or depositing the transferred amount of money to bank accounts associated with the first user equipment and the second user equipment.

18. The method of claim 11, comprising:
generating an online money transfer result message to include information on a result of perform the online money transfer operation; and
transmitting the generated result message to the first user equipment and the second user equipment.

19. User equipment for performing an online money transfer operation in connection with an instant messenger, the user equipment configured to:
monitor messages transmitted to and received from second user equipment through the instant messenger upon initiation of the online money transfer operation;
obtain information on an online money transfer event upon detection of a predetermined service initiation word based on the monitoring result; and
request a service server to perform the online money transfer operation based on the obtained information.

20. The user equipment of claim 19, wherein the user equipment is configured to:
receive a confirmation message from the service server in response to the request;
display the confirmation message within a graphic user interface of the instant messenger and inquire an associated user to select one of confirmation approval and for confirmation denial;
transmit at least one of a confirmation approval message and a confirmation denial message to the service server based on the user selection; and
receive an online money transfer result from the service server.
